(19) United States
(12) Patent Application Publication
(10) Pub. No.: US 2012/0156909 A1
(43) Pub. Date: Jun. 21, 2012

(54) POWER CONNECTOR ASSEMBLY

(75) Inventor: ADAM PRICE TYLER, ROCHESTER HILLS, MI (US)

(73) Assignee: TYCO ELECTRONICS CORPORATION, BERWYN, PA (US)

(21) Appl. No.: 12/971,175

(22) Filed: Dec. 17, 2010

(51) Int. Cl. H01R 13/15

(52) U.S. Cl. 439/259

(57) ABSTRACT

A power connector includes a holder having a cavity and a tab extending into the cavity. Power contacts are received within the cavity in a stacked configuration. The power contacts have a first end and a second end. The power contacts have a first receptacle section at the first end configured to receive a power terminal therein and a second receptacle section at the second end configured to receive a power terminal therein. The power contacts have an opening, wherein the tab is received in the openings to position the contacts within the cavity.

### BACKGROUND OF THE INVENTION

The subject matter herein relates generally to electrical connectors, and more particularly, to assemblies for retaining contacts in electrical connectors.

Electrical connectors having the capability to carry high electrical currents are useful in a variety of applications. For example, in automobiles, such a connector can be used in a power distribution center to carry current between components or to bring current to particular components, such as a battery pack, an alternator, an inverter, or an electric motor of an electric or hybrid vehicle.

The components of such systems may include a power bus bar having terminals extending therefrom. The components are typically interconnected using a wire harness having individual connectors terminated to ends of wires that are connected to the terminals of the power bus bar and routed between the components. However, coupling the individual connectors to the individual terminals may be time consuming. Additionally, terminating the individual connectors to the ends of the wires may be time consuming and expensive. To overcome the problems with using wire harnesses, at least some systems are known that utilize power connectors between the components, where the terminals of the power bus bars are plugged into the power connectors to make an electrical connection therebetween. However, such systems are not without disadvantages. For instance, when trying to connect the power connector between different components, angular and/or positional mismatch between the terminals of the two components can make the process of creating a reliable electrical connection difficult, time consuming and/or expensive.

Thus, a need exists for a power connector capable of connecting power bus bar terminals of two electronic components in a reliable and cost effective manner. A need remains for a power connector capable of connecting power bus bar terminals of two electrical components despite angular and positional mismatch in a time and cost effective manner.

### BRIEF DESCRIPTION OF THE INVENTION

In one embodiment, a power connector is provided that includes a holder having a cavity and a tab extending into the cavity. Power contacts are received within the cavity in a stacked configuration. The power contacts have a first end and a second end. The power contacts have a first receptacle section at the first end configured to receive a power terminal therein and a second receptacle section at the second end configured to receive a power terminal therein. The power contacts have an opening, wherein the tab is received in the openings to position the contacts within the cavity.

In another embodiment, a power contact is provided with a contact body having a first end and a second end with upper and lower arms and an intermediate section therebetween. The contact body has a first receptacle section between the intermediate section and the first end. The first receptacle section is configured to receive a power terminal therein. The contact body has a second receptacle section between the intermediate section and the second end that is configured to receive a power terminal therein. The contact body has an opening in the intermediate section offset from a centerline of the contact body.

In a further embodiment, a power connector assembly is provided including a housing having chambers and power connectors received in the chambers. Each power connector includes a holder having a cavity and a tab extending into the cavity. Power contacts are received within the cavity in a stacked configuration. The power contacts have a first end and a second end. The power contacts have a first receptacle section at the first end configured to receive a power terminal therein. The power contacts have a second receptacle section at the second end configured to receive a power terminal therein. The power contacts have an opening, wherein the tab is received in the openings to position the power contacts within the cavity.

### BRIEF DESCRIPTION OF THE DRAWINGS

FIG. 1 illustrates a power connector system showing a power connector assembly formed in accordance with an embodiment.

FIG. 2 illustrates one of the power contacts used within the power connector assembly shown in FIG. 1 in accordance with an embodiment.

FIG. 3 is a front perspective view of the power connector assembly shown in FIG. 1 with a power connector exploded showing the components thereof in accordance with an embodiment.

FIG. 4 is a top sectional view of the power connector with the power terminals mated with the stack of power contacts in accordance with an embodiment.

FIG. 5 is a side view of the power connector with a cover thereof removed illustrating angular offset of power terminals inserted into the power connector slots in accordance with an embodiment.

FIG. 6 is a side sectional view of the power connector with the cover removed illustrating vertical offset and variable insertion depths of power terminals inserted in the power connector.

FIG. 7 is a side perspective view of the power connector with the cover removed illustrating twist angular offset of power terminals inserted in the power connector slots in accordance with an embodiment.

FIG. 8 illustrates a locator spring for use with the power connector shown in FIG. 3 in accordance with an embodiment.

FIG. 9 is an exploded view of an alternative power connector for the power connector assembly shown in FIG. 3 in accordance with an embodiment.

FIG. 10 illustrates another alternative power connector with power terminals installed in different orientations in accordance with an embodiment.

FIG. 11 is an exploded perspective view of the power connector shown in FIG. 10.

FIG. 12 illustrates an alternate power connector system showing a power connector assembly formed in accordance with an embodiment.

FIG. 13 is an exploded view of the power connector assembly shown in FIG. 12.

FIG. 14 is a partial sectional view of the power connector assembly with a portion of a housing thereof removed to show power terminals of a cable assembly mated with power contacts of the power connector assembly.

FIG. 15 is a cross-sectional view of the power connector assembly shown in FIG. 12 mated with a header assembly.

### DETAILED DESCRIPTION OF THE INVENTION

In the following detailed description, reference is made to the accompanying drawing which form a part hereof, and in which are shown by way of illustration specific embodiments in which the present invention may be practiced. These embodiments, which are also referred to herein as “examples,” are described in sufficient detail to enable those skilled in the art to practice the invention. It is to be understood that the embodiments may be combined or that other embodiments may be utilized, and that structural, logical, and electrical variations may be made without departing from the scope of the present invention. The following detail description is, therefore, not to be taken in a limiting sense, and the scope of the present invention is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated.

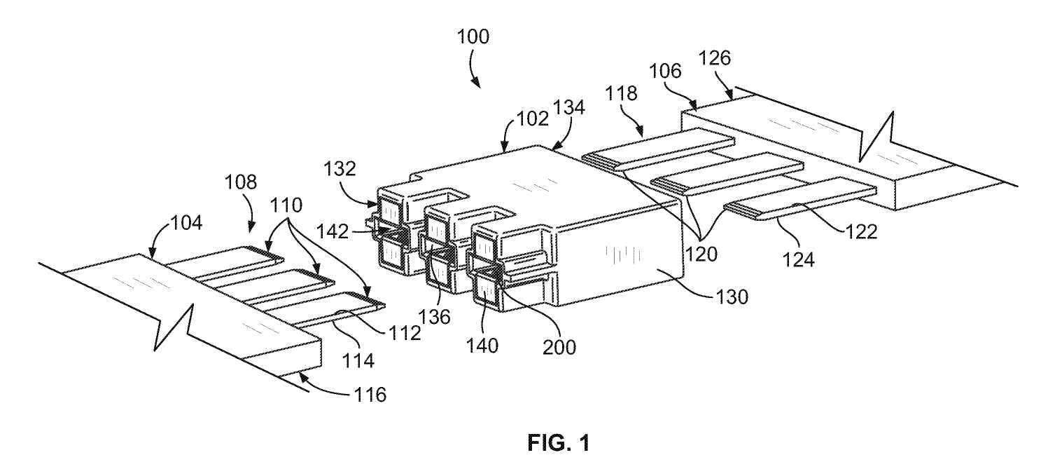

FIG. 1 illustrates a power connector system 100 formed in accordance with an embodiment. The power connector system 100 includes a power connector assembly 102 used to interconnect a first power device 104 and a second power device 106. In an exemplary embodiment, the power connector assembly 102 constitutes a double-ended, high current connector assembly, which serves to conduct high voltage and high current between the first power device 104 and the second power device 106.

The first and second power devices 104, 106 may be any types of electronic devices or power devices. In one particular application, the power connector system 100 is utilized in an electric or hybrid vehicle. The power connector assembly 102 is utilized to interconnect an inverter, represented by the first power device 104 and an electric motor, represented by the second power device 106. The power connector assembly 102 may be utilized to interconnect other types of devices within the electric or hybrid vehicle. The power connector assembly 102 may be utilized in other types of vehicles, equipment or in other applications in alternative embodiments.

The first power device 104 includes a plurality of power terminals 110 combined onto a power bus bar 108. Any number of power terminals 110 may be provided within the power bus bar 108. In an exemplary embodiment, the power terminals 110 are blade terminals. The power terminals 110 have opposite sides 112, 114 that are planar and extend parallel to one another. Optionally, the sides 112 of each power terminal 110 are coplanar and the sides 114 of each power terminal 110 are coplanar. The power terminals 110 may be held within a housing 116. The housing 116 may have any shape or size depending on the particular embodiment or application. The housing 116 may be sized and shaped to at least partially receive the power connector assembly 102.

The second power device 106 includes a plurality of power terminals 120 combined onto a power bus bar 118. Any number of power terminals 120 may be provided within the power bus bar 118. In an exemplary embodiment the power terminals 120 are blade terminals. The power terminals 120 have opposite sides 122, 124 that are planar and extend parallel to one another. Optionally, the sides 122 of each power terminal 120 are coplanar and the sides 124 of each power terminal 120 are coplanar. The power terminals 120 may be held within a housing 126. The housing 126 may have any shape or size depending on the particular embodiment or application. The housing 126 may be sized and shaped to at least partially receive the power connector assembly 102.

The power connector assembly 102 includes a housing 130 extending between a first side 132 and a second side 134. The housing 130 includes a plurality of chambers 136 therein that extend between the first and second sides 132, 134. Any number of chambers 136 may be provided, including a single chamber.

The power connector assembly 102 includes a plurality of individual power connectors 140 held within corresponding chambers 136. Optionally, the power connectors 140 are identically formed. The power connectors 140 are configured to be electrically connected with corresponding power terminals 110, 120 of the first and second power devices 104, 106. The power connectors 140 electrically connect the first and second power devices 104, 106. In an exemplary embodiment, the housing 130 includes slots 142 at the first side 132 that provide access to the power connectors 140 and similar slots (not shown) at the second side 134 that provide access to the other side of the power connectors 140. The power terminals 110 are loaded through the slots 142 at the first side 132 for mating with the power connectors 140. The power terminals 120 are loaded through the slots 142 at the second side 134 for mating with the power connectors 140.

Each power connector 140 includes a plurality of power contacts 200 that are configured to engage corresponding power terminals 110 and power terminals 120. The power contacts 200 transmit high voltage and high current between the power terminals 110 and 120. In an exemplary embodiment, each power contact 200 engages both sides 112, 114 of the power terminals 110 and each power contact 200 engages both sides 122, 124 of the power terminals 120.

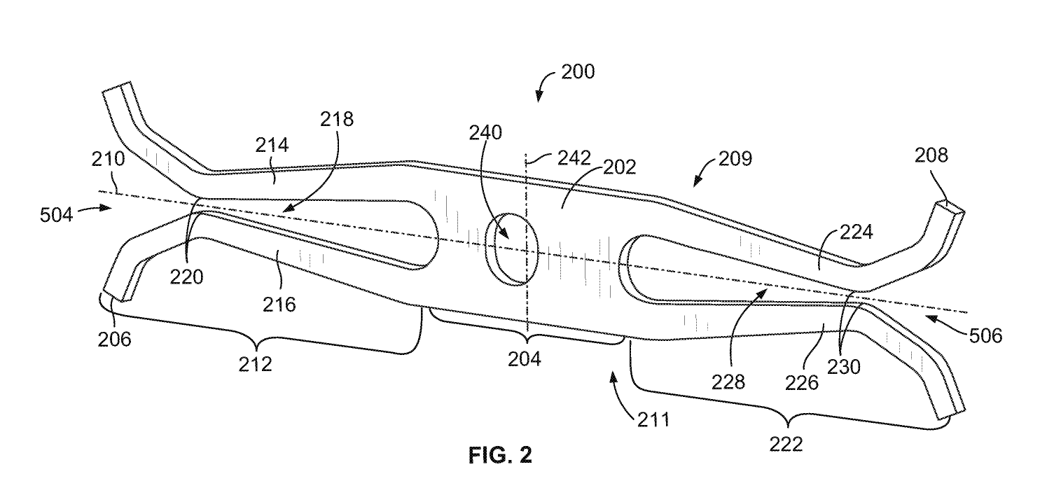

FIG. 2 illustrates one of the power contacts 200 used within the power connector system 100 in accordance with an embodiment. The power contact 200 includes of a contact body 202 having a unitary, one-piece construction. The power contact 200 extends between a first end 206 and a second end 208 with an intermediate section 204 therebetween. Optionally, the power contact 200 may be symmetrical about a longitudinal axis 210 of the power contact 200 defining an upper section 209 and a lower section 211 that are identical to one another. The upper and lower sections 209, 211 are integrally formed with one another as part of a one piece contact body 202.

The contact body 202 includes a first receptacle section 212 at the first end 206. The first receptacle section 212 extends between the first end 206 and the intermediate section 204. The first receptacle section 212 is configured to receive a corresponding power terminal 110 (shown in FIG. 1) therein. The first receptacle section 212 is defined by an upper arm 214 and a lower arm 216, which have a gap 218 therebetween. The power terminal 110 is received in the gap 218 between the upper and lower arms 214, 216. The upper and lower arms 214, 216 extend outward from the intermediate section 204. Optionally, the upper and lower arms 214, 216 may extend toward one another and converge at mating interfaces 220. The mating interfaces 220 are the portions of the upper and lower arms 214, 216 that engage the power terminal 110. Distal ends of the upper and lower arms 214, 216 may be flared outward from the mating interfaces 220 away from one another to form lead-in sections 504 for receiving the power terminal 110. The lead-in section 504 prevents stubbing when mating with the power terminal 110. The lead-in section 504 is defined by the distal ends of the upper and lower arms 214, 216 that are flared outward from the mating interfaces 220. The lead-in section 504 accommodates angular offset of the power terminals 110 from the longitudinal axis 210.

In an exemplary embodiment, the upper and lower arms 214, 216 constitute spring beams that are configured to be deflected when mated with the power terminal 110. The upper and lower arms 214, 216 may be spring biased against the sides 112, 114 (shown in FIG. 1) of the power terminal 110 to ensure good electrical connection between the power contact 200 and the power terminal 110.

The contact body 202 includes a second receptacle section 222 at the second end 208. The second receptacle section 222 extends between the second end 208 and the intermediate section 204. The second receptacle section 222 is configured to receive a corresponding power terminal 120 (shown in FIG. 1) therein. The second receptacle section 222 is defined by an upper arm 224 and a lower arm 226, which have a gap 228 therebetween. The power terminal 120 is received in the gap 228 between the upper and lower arms 224, 226. The upper and lower arms 224, 226 extend outward from the intermediate section 204. Optionally, the upper and lower arms 224, 226 may extend toward one another and converge at mating interfaces 230. The mating interfaces 230 are the portions of the upper and lower arms 224, 226 that engage the power terminal 120. Distal ends of the upper and lower arms 224, 226 may be flared outward from the mating interfaces 230 away from one another to form a lead-in section 506 that prevents stubbing when mating with the power terminal 110. The lead-in section 506 is flared outward from the mating interfaces 230 to accommodate the angular offset of the power terminals 120 from the longitudinal axis 210 to the mating interface.

In an exemplary embodiment, the upper and lower arms 224, 226 constitute spring beams that are configured to be deflected when mated with the power terminal 120. The upper and lower arms 224, 226 may be spring biased against the sides 122, 124 (shown in FIG. 1) of the power terminal 120 to ensure good electrical connection between the power contact 200 and the power terminal 120.

In an exemplary embodiment, the intermediate section 204 along with the arms 214, 216, 224, 226 form an integral part of a unitary contact body 202. High voltage electric power is transmitted through the power contact 200 efficiently by having the contact body 202 formed as a unitary structure.

The mating interfaces 220, 230 are curved to define a single point of contact between each arm 214, 216, 224, 226 and the corresponding power terminal 110, 120. The curved nature of the mating interfaces 220, 230 along with the lead-in sections 504, 506 accommodate angular offset of the power terminals 110, 120 within the corresponding receptacle sections 212, 222. The stacked formation of the power contacts 200 accommodates angular offset of the power terminals 110, 120 because the power contacts 200 are movable relative to one another. The receptacle sections 212, 222 include forked contact portions configured to receive the power terminals 110, 120 therein. The arms 214, 216 define the forked contact portion of the first receptacle section 212 and the arms 224, 226 define the forked contact portion of the second receptacle section 222. The amount of flaring out of the arms 214, 216, 224, 226 may be controlled to define a larger window into the receptacle sections 212, 222, which may also help to accommodate offset of the power terminals 110, 120 with respect to the gaps 218, 228. The flaring provides a lead-in into the gaps 218, 228.

The contact body 202 includes an opening 240 in the intermediate section 204. In an exemplary embodiment, the opening 240 is offset from a vertical centerline 242 of the contact body 202. The opening 240 may be elongated in a direction transverse to the contact axis 210. When multiple power contacts 200 are stacked together in a stacked configuration, some power contacts 200 may be inverted with respect to other power contacts 200. For example, adjacent power contacts 200 may be inverted such that every other power contact 200 is rotated 180°. The offset of the opening 240 creates a staggered arrangement of the power contacts 200 within the stacked configuration by placing the opening 240 on alternating sides of the centerline 242. In the illustrated embodiment, the opening 240 is provided internally within the intermediate section 204 away from any edges of the contact body 202. The opening 240 is elongated top-to-bottom in a direction perpendicular to the longitudinal axis 210. The opening 240 is oval shaped. Other shapes may be possible in alternative embodiments. Additionally, the opening 240 may be positioned in other locations in alternative embodiments. For example, the opening 240 may be positioned along one of the edges of the contact body 202. In an alternative embodiment, multiple openings 240 may be provided. The openings 240 may be provided along the edges of the contact body 202. Alternatively, the opening 240 may be provided internally within the intermediate section 204.

The power contact 200 may be manufactured using a cost effective stamping process. In an exemplary embodiment, each power contact 200 within the stack may be identical to one another, thereby simplifying the manufacturing process. The power contact 200 is manufactured by stamping to create the gaps 218, 228, which may be tightly controlled by the stamping process. Also, the arms 214, 216, 224, 226 are created with no forming stress. The low stress allows for use of a relatively inexpensive, high conductivity material in manufacturing of the power contact 200. For example, the high conductive material may be copper or copper alloy. Alternatively, the power contact 200 may be manufactured using other processes, including a forming process. Optionally, the power contact 200 may be plated with a conductive material, such as with silver plating. The power contact 200 may be selectively plated, such as only at the mating interfaces 220, 230.

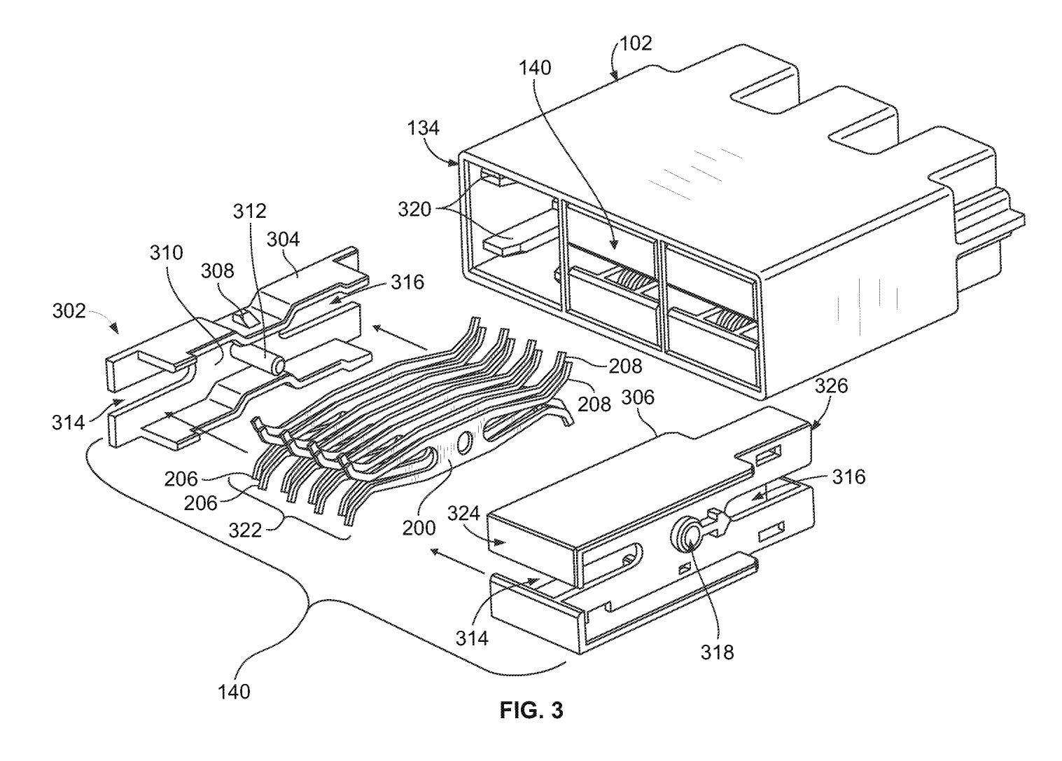

FIG. 3 is a front prospective view of the power connector assembly 102 with one of the power connectors 140 exploded showing the components thereof in accordance with an embodiment. The power connector 140 includes a holder 302 with a first end 324 and a second end 326. The holder 302 holds a plurality of the power contacts 200 in a stacked configuration as a power contact stack 322. The power contacts 200 are stacked such that the first receptacle sections 212 (shown in FIG. 2) are aligned with one another to receive the same power terminal 110 (shown in FIG. 1) and the second receptacle sections 222 are aligned with one another to receive the same power terminal 120 (shown in FIG. 1). At least some of the first ends 206 are offset from other first ends 206 and such that at least some of the second ends 208 are offset from other second ends 208.

The holder 302 is of a two piece construction, having a base 304 and a cover 306. The power contacts 200 are loaded onto the base 304 and the cover 306 is attached to the base 304 to cover the power contact stack 322. The cover 306 is attached to the base 304 using a latch 308 extending from the base 304 and a corresponding locking mechanism (not shown) is provided on the cover 306.

The holder 302 defines a cavity 310 between the base 304 and the cover 306 extending from the first end 324 to the second end 326. The power contact stack 322 is received within the cavity 310. In an exemplary embodiment, the base 304 includes a tab 312 extending into the cavity 310. The power contacts 200 are loaded onto the tab 312. In the illustrated embodiment, the tab 312 is cylindrical. The power contacts 200 are loaded onto the tab 312 and are allowed to float on the tab 312 in directions transverse to the contact axis 210. For example, the power contacts 200 may be coupled to the base 304 such that the tab 312 is received in the elongated openings 240. The power contacts 200 may be movable up or down on the tab 312. In an exemplary embodiment, adjacent power contacts 200 within the stack 322 are inverted (rotated 180°) with respect to one another and loaded onto the tab 312. Because the openings 240 are off-set, the power contacts 200 are staggered within the stack 322. For example, the staggering can be longitudinal or vertical. The number of power contacts 200 in the stack 322 is scalable to increase or decrease the current carrying capability of the power connector 140. For example, to increase the current carrying capability of the power connector 140, additional power contacts 200 may be added to the stack 322. Conversely, to decrease the current carrying capability of the power connector 140, power contacts 200 may be subtracted from the stack 322.

In the illustrated embodiment, eight power contacts 200 are provided within the stack 322, which provides eight independent contact points on each of the sides 112, 114, 122, 124 (shown in FIG. 1) of the power terminals 110, 120 (shown in FIG. 1). In an exemplary embodiment, the layered power contacts provide multiple points of contact, with a conductance equal to or greater than that of the power terminals 110, 120.

The holder 302 includes a slot 314 at the first end 324 of the power connector 140. The holder 302 also includes a slot 316 at the second end 326 of the power connector 140. The slots 314, 316 on opposite end of the power connector provide access to the cavity 310. The slots 314, 316 provide access to the power contacts 200. The power terminals 110, 120 are inserted into the slots 314, 316, respectively, for mating with the power contacts 200. Optionally, the slots 314, 316 may be oversized relative to the size of the power terminals 110, 120 to accommodate off-set of the power terminals 110, 120 with respect to the power connector 140. For example, the slots 314, 316 may have an oversized width to accommodate side-to-side off-set of the power terminals 110, 120. The slots 314, 316 may have an oversized height to accommodate top-to-bottom or angular off-set of the power terminals 110, 120.

The holder 302 includes lock fingers 318 along sides of the cover 306 and/or the base 304. The lock fingers 318 retain the power connector 140 in the power connector assembly housing 130. During assembly, the holder 302 is assembled together by loading the stack 322 onto the tab 312 of the base 304 and then coupling the base 304 and the cover 306. The holder 302 is then loaded into the chamber 136 of the housing 130 through the second end 134. The lock fingers 318 engage corresponding locking features (not shown) in the chamber 136 to hold the power connector 140 in the chamber 136. Optionally, guide rails 320 may be provided within the chamber 136 for guiding the power connector 140 therein. The staggered power contact stack 322 requires a low coupling force for the power terminals 110, 120 with a low rate of wear and high coupling durability. The power contact stack 322 provides a shock and vibration resistant power supply, thereby allowing the power connector assembly 102 to operate in harsh environments.

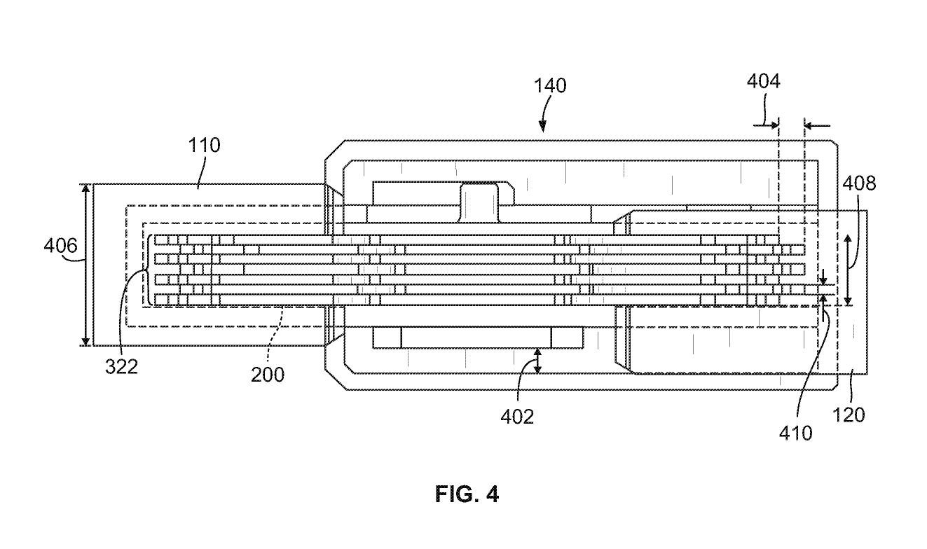

FIG. 4 is a top sectional view of the power connector 140 with the power terminals 110, 120 mated with the stack 322 of power contacts 200 in accordance with an embodiment. The power contacts 200 are staggered within the stack 322 such that adjacent power contacts 200 are offset longitudinally by an offset distance 404. Having the power contacts 200 staggered reduces the overall mating force by staggering the mating interfaces 220, 230 (shown in FIG. 2), thus reducing the mating friction between the power contacts 200 and the power terminals 110, 120.

The power contacts 200 have narrow widths 410 as compared to a width 406 of the power terminals 110, 120. The stack 322 has a stack width 408 that is equal to the sum of the widths 410 of the individual power contacts 200. In an exemplary embodiment, the stack width 408 is less than the width 406 of the power terminals 110, 120. As such, the stack 322 can accommodate a relatively high degree of lateral offset 402 of the power terminals 110, 120 with respect to one another. The stack 322 can accommodate lateral (e.g. side-to-side) shifting of the power terminals 110, 120 within the slots 314, 316 (shown in FIG. 3) and within the receptacle sections 212, 222 (shown in FIG. 2). For example, when the power connector assembly 102 (shown in FIG. 1) is offset with respect to the first and/or second power device 104, 106 (shown in FIG. 1), the power terminals 110, 120 may be shifted toward one side or the other side of the slots 314, 316. Having the stack width 408 relatively narrow as compared to the power terminal width 406, allows the power terminals 110, 120 to be shifted with respect to the stack 322, while still allowing the stack 322 to make full electrical contact with the power terminals 110, 120.

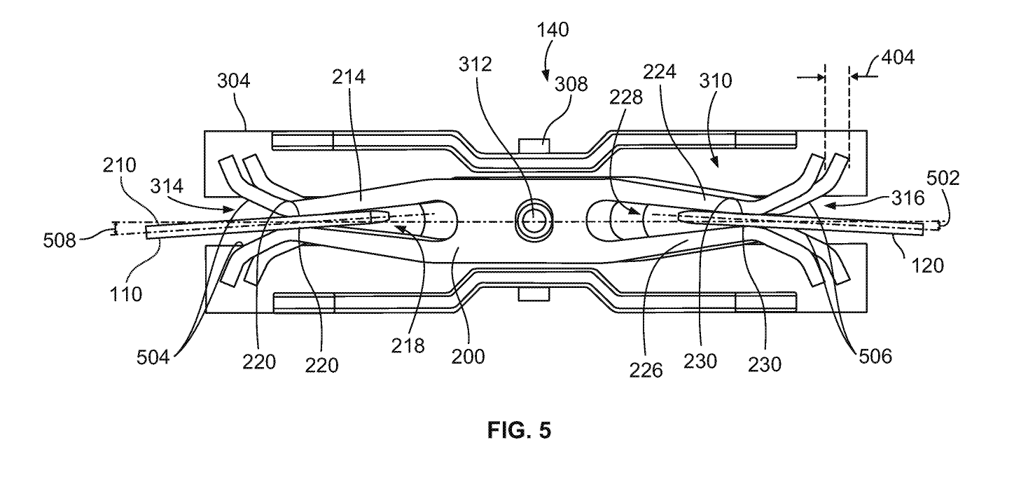

FIG. 5 is a side view of the power connector assembly 102 with the cover 306 (shown in FIG. 3) removed. FIG. 5 illustrates vertical angular offset of the power terminals 110, 120 inserted into the power connector 140 slots 314, 316. The power contacts 200 are configured to accommodate a range of angular offset 502, 508 of the power terminals 110, 120. For example, when the first and/or second power devices 104, 106 (shown in FIG. 1) are mated with the power connector assembly 102 (shown in FIG. 1) at an angle, the power contacts 200 accommodate such angular offset 502, 508 of the power terminals 110, 120, which is measured from the longitudinal axis 210.

The power contacts 200 have lead-in sections 504, 506 at the first and second ends 206, 208 that provide a space for directing the power terminals 110, 120 into the receptacle sections 212, 222. The lead-in sections 504, 506 are flared outward from the mating interfaces 220, 230, respectively, to accommodate the angular offset 502, 508 of the power terminals 110, 120 from the longitudinal axis 210 distal to the mating interface. Additionally, the upper and lower arms 214, 216, 224, 226 are angled away from the opposite arm, at the mating interfaces 220, 230, making the gaps 218, 228 between the arms larger. The large gaps 218, 228 further accommodate the angular offsets 502, 508 of the power terminals 110, 120 from the longitudinal axis 210 proximal to the mating interfaces 220, 230. The large gaps 218, 228 accommodate the angular offsets 502, 508 by providing an angled path for the terminals 110, 120 through lead-in section 504, 506 through the mating interfaces 220, 230 and into the gaps 218, 228. The power contacts 200 have a forked-shape that withstands a high degree of terminal blade pitch angularity with very little change to beam stress of the power contacts 200. The curved shape of the mating interfaces 220, 230 accommodates the angular offset 502, 508 while maintaining electrical contact with the power terminals 110, 120.

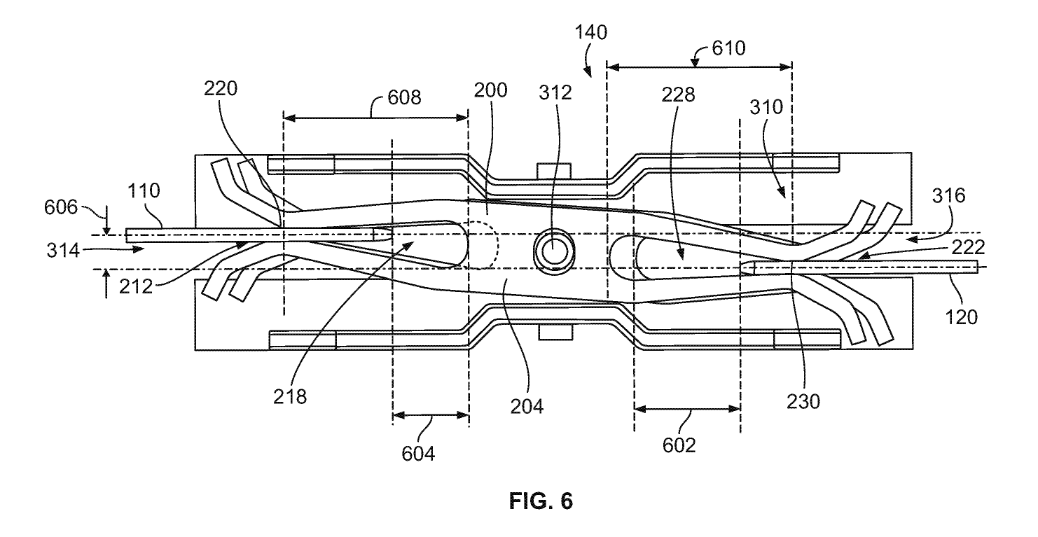

FIG. 6 is a side view of the power connector 140 with the cover 306 (shown in FIG. 3) removed. FIG. 6 illustrates vertical offset and variable insertion depths 602, 604 of the power terminals 110, 120 inserted in the power connector 140. The power contacts 200 are configured to accommodate variable insertion depths 602, 604 of the power terminals 110, 120. The power contact 200 can withstand a high degree of vertical offset 606 (e.g. top-to-bottom) of the power terminals 110, 120. FIG. 6 illustrates the power terminal 110 at a top of the first slot 314 and the power terminal 120 at a bottom of the slot 316. The power contact 200 is pivoted about the tab 312 allowing the power contacts 200 to rotate within the cavity 310. The ability of the power contacts 200 to withstand angularity and angular offset, and the power contacts 200 ability to rotate on the tab 312, allows the power connector assembly 102 to withstand a relatively high degree of vertical offset 606 of the power terminals 110, 120.

The receptacle sections 212, 222 form a female fitting, opening into the gaps 218, 228. The gaps 218, 228 have lengths 608, 610 measured from the mating interfaces 220, 230 to the intermediate section 204. The lengths 608, 610 of the gaps 218, 228 allow the power contact 200 to accommodate a high degree of variation of insertion depths 604, 602 of the power terminals 110, 120 into the receptacle sections 212, 222. As such, the position of the power connector assembly 102 with respect to the first and second power devices 104, 106 (shown in FIG. 1) may be varied, while still allowing the power contacts 200 to mate with the power terminals 110, 120.

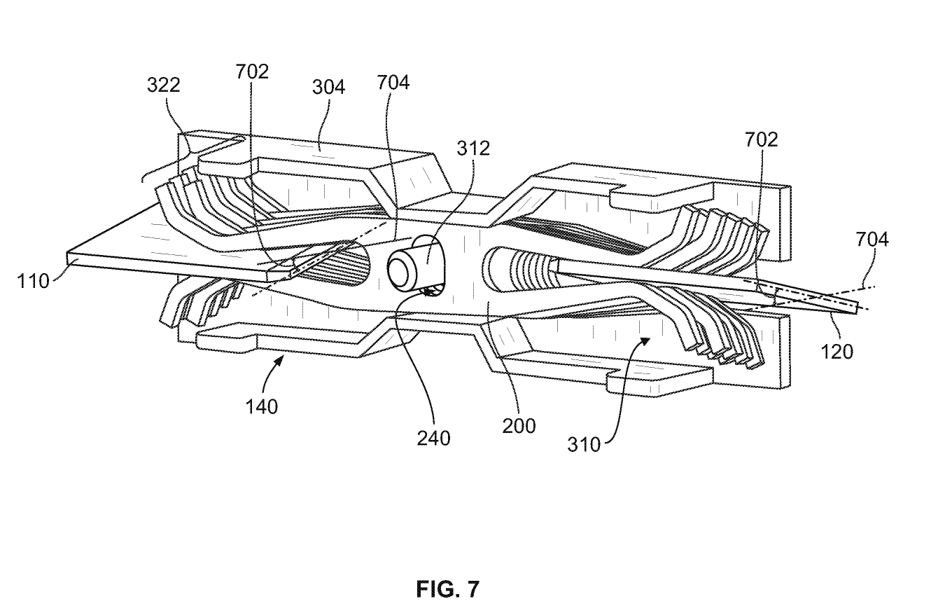

FIG. 7 is a side perspective view of the power connector assembly 102 with the cover 306 (shown in FIG. 3) removed. FIG. 7 illustrates yet another angular offset of the power terminals 110, 120 inserted in the base 304 of the power connector 140. FIG. 7 illustrates blade twist angularity of the power terminals 110, 120, where the power terminals 110, 120 are angled at a twist angle 702 with respect to a central plane 704 of the slots 314, 316 (shown in FIG. 3). The power contacts 200 are pivoted on the tab 312 allowing the power contacts 200 to rotate within the cavity 310 to accommodate the blade twist of the power terminals 110, 120. In an exemplary embodiment, the openings 240 are oval-shaped allowing each power contact 200 in the stack 322 to independently rotate around the tab 312 and to move laterally on the tab 312. The ability of power contacts 200 to rotate allows the power contact stack 322 to tolerate a high degree of blade twist angularity. Having the openings 240 elongated allows the power contacts 200 to float up and down on the tab 312. Some of the power contacts 200 may be shifted higher within the cavity 310, while some of the power contacts 200 may be shifted lower within the cavity 310 to accommodate the blade twist.

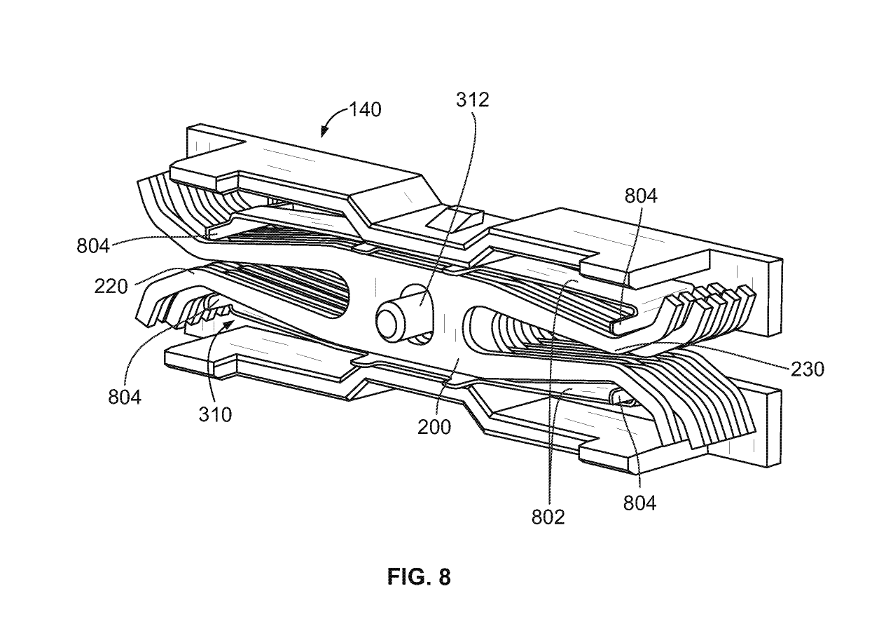

FIG. 8 is a side perspective view of the power connector 140 with the cover 306 (shown in FIG. 3) removed. FIG. 8 illustrates locator springs 802 loaded into the cavity 310. In one embodiment the locator springs 802 are bent about the ends to form fingers 804. The fingers 804 engage the power contacts 200 of the power contact stack 322, such as in the vicinity of the mating interfaces 220, 230. The locator springs 802 engage the power contacts 200 to hold the power contacts 200 in a neutral position within the cavity 310. The locator springs 802 tend to force the power contacts 200 toward the neutral position when the power contacts 200 are moved out of the neutral position, such as when the power terminals 110, 120 (shown in FIG. 1) are loaded into the power connector 140 in an off-set position (e.g. vertical off-set, angular off-set, twisted off-set and the like). The locator springs 802 allow the power contact stack 322 to stay centered prior to insertion of the power terminals 110, 120. In an exemplary embodiment, the locator springs 802 may have a low bending and torsional stiffness thereby allowing the power connector 140 to accommodate angularity and/or offset of the power terminals 110, 120.

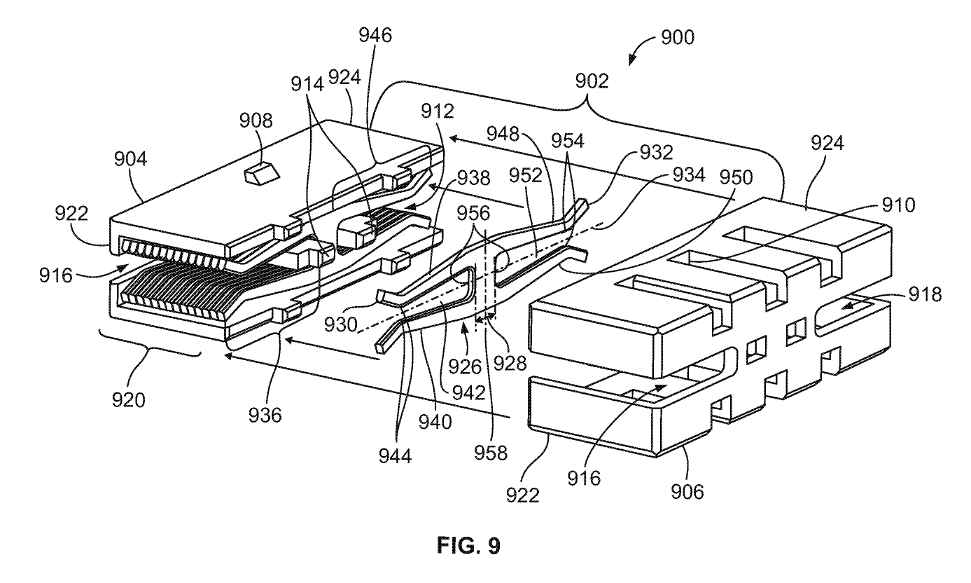

FIG. 9 is an exploded view of an alternative power connector 900 formed in accordance with an embodiment for the power connector assembly 102. The power connector 900 may be used in place of the power connector 140 (shown in FIG. 1). The power connector 900 includes a holder 902 with a first end 922 and a second end 924. The holder 902 holds a plurality of the power contacts 926 in a stacked configuration as a power contact stack 920. The holder 902 is of a two piece construction, having a base 904 and a cover 906. The power contacts 926 are loaded onto the base 904 and the cover 906 is attached to the base 904 to cover the power contact stack 920. The cover 906 is attached to the base 904 using a latch 908 extending from the base 904 and corresponding locking mechanism 910 (e.g. a catch) on the cover 906.

The holder 902 defines a cavity 912 between the base 904 and the cover 906. The power contact stack 920 is received within the cavity 912. In an exemplary embodiment, the base 904 includes tabs 914 extending into the cavity 912. The power contacts 926 are loaded onto the tabs 914. For example, the power contacts 926 may be coupled to the base 904 such that the tabs 914 are received in openings 956 of the power contacts 926. In an alternative embodiment, the openings 956 may be off-set and the adjacent power contacts 926 within the stack 920 are inverted (rotated 180°) with respect to one another and loaded onto the tab 914. The off-set, along with inversion of alternating power contacts 926, allows the power contacts 926 to be staggered within the stack 920. The number of power contacts 926 in the stack 920 is scalable to allow increase or decrease in current carrying capability of the power connector.

The holder 902 includes a slot 916 at the first end 922 of the power connector 900. The holder 902 also includes a slot 918 at the second end 924 of the power connector 900. The slots 916, 918 on opposite end of the power connector provide access to the cavity 912. The slots 916, 918 provide access to the power contacts 926. The power terminals 110, 120 (shown in FIG. 1) are inserted into the slots 916, 918, respectively, for mating with the power contacts 926.

The power contact 926 is a unitary, one-piece construction. The power contact 926 extends between a first end 930 and a second end 932 with an intermediate section 928 therebetween. Optionally, the power contact 926 may be symmetrical about a longitudinal axis 934 of the power contact 926 defining an upper section and a lower section that are identical to one another.

The power contact 926 includes a first receptacle section 936 at the first end 930. The first receptacle section 936 extends between the first end 930 and the intermediate section 928. The first receptacle section 936 is configured to receive a corresponding power terminal 110 therein. The first receptacle section 936 is defined by an upper arm 938 and a lower arm 940, which have a gap 942 therebetween. The power terminal 110 is received in the gap 942 between the upper and lower arms 938, 940. The upper and lower arms 938, 940 extend outward from the intermediate section 928. Optionally, the upper and lower arms 938, 940 may extend toward one another and converge at mating interfaces 944. The mating interfaces 944 are the portions of the upper and lower arms 938, 940 that engage the power terminal 110. Distal ends of the upper and lower arms 938, 940 may be flared outward from the mating interfaces 944 away from one another to define a lead-in section that prevents stubbing when mating with the power terminal 110. The lead-in section is flared outward from the mating interfaces 944 to accommodate the angular offset of the power terminals 110 from the longitudinal axis 934 to the mating interface.

In an exemplary embodiment, the upper and lower arms 938, 940 constitute spring beams that are configured to be deflected when mated with the power terminal 110. The upper and lower arms 938, 940 may be spring biased against the sides 112, 114 (shown in FIG. 1) of the power terminal 110 to ensure good electrical connection between the power contact 926 and the power terminal 110.

The power contact 926 includes a second receptacle section 946 at the second end 932. The second receptacle section 946 extends between the second end 932 and the intermediate section 928. The second receptacle section 946 is configured to receive a corresponding power terminal 120 therein. The second receptacle section 946 is defined by an upper arm 948 and a lower arm 950, which have a gap 952 therebetween. The power terminal 120 is received in the gap 952 between the upper and lower arms 948, 950. The upper and lower arms 948, 950 extend outward from the intermediate section 928. Optionally, the upper and lower arms 948, 950 may extend toward one another and converge at mating interfaces 954. The mating interfaces 954 are the portions of the upper and lower arms 948, 950 that engage the power terminal 120. Distal ends of the upper and lower arms 948, 950 may be flared outward from the mating interfaces 954 away from one another to define a lead-in section that prevents stubbing when mating with the power terminal 110. The lead-in section is flared outward from the mating interfaces 954 to accommodate the angular offset of the power terminals 120 from the longitudinal axis 934 to the mating interface.

In an exemplary embodiment, the upper and lower arms 948, 950 constitute spring beams that are configured to be deflected when mated with the power terminal 120. The upper and lower arms 948, 950 may be spring biased against the sides 122, 124 (shown in FIG. 1) of the power terminal 120 to ensure good electrical connection between the power contact 926 and the power terminal 120.

In an exemplary embodiment, the intermediate section 928 and the arms 938, 940, 948, 950 are an integral part of a unitary power contact 926. High voltage electric power is transmitted through the power contact 926 efficiently by having the power contact 926 formed as a unitary structure.

The mating interfaces 944, 954 are curved to define a single point of contact between each arm 938, 940, 948, 950 and the corresponding power terminal 110, 120. The curved nature of the mating interfaces 944, 954 accommodates angular offset of the power terminal 110, 120 within the corresponding receptacle section 936, 946. The amount of flaring out of the arms 938, 940, 948, 950 may be controlled to define a larger window into the receptacles 936, 946, which may also help to accommodate offset of the power terminals 110, 120 with respect to the gaps 942, 952. The flaring provides a lead-in into the gaps 942, 952.

The power contact 926 includes the openings 956 at the edges of the intermediate section 928. Optionally, the openings 956 may be offset from a centerline 958 of the power contact 926. When multiple power contacts 926 are stacked together in a stacked configuration, adjacent power contacts 926 may be inverted with respect to one another. The offset of the openings 956 creates a staggered arrangement of the power contacts 926 within the stacked configuration by shifting the openings 956 on alternating sides of the centerline 958. In the illustrated embodiment, the openings 956 are provided at the proximal ends of the gaps 942, 952, such as at the intermediate section 928.

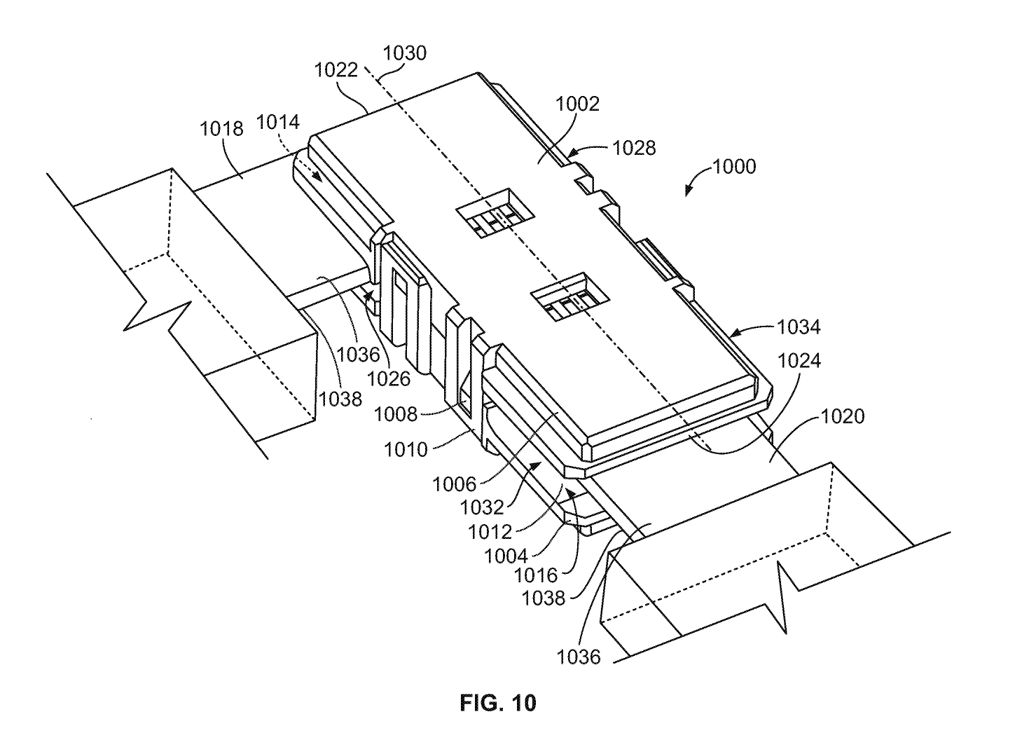

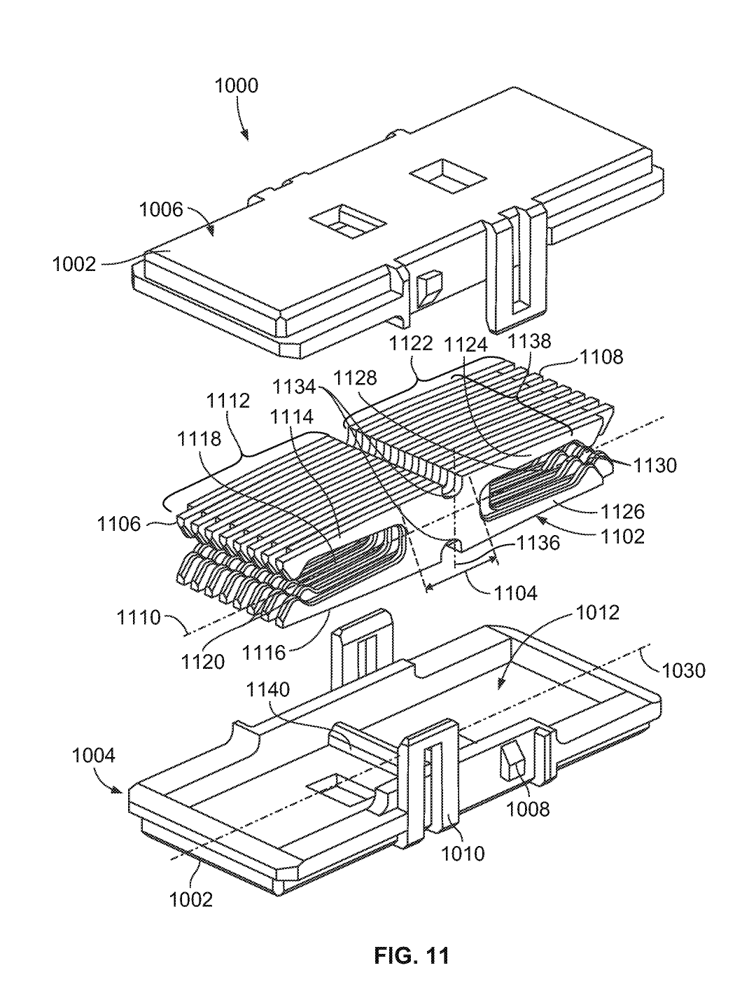

FIG. 10 illustrates another alternative power connector 1000 formed in accordance with an embodiment for the power connector assembly 102. The power connector 1000 may be used in place of the power connector 140 (shown in FIG. 1). The power connector 1000 includes a holder 1002 with a first end 1022 and a second end 1024. The holder 1002 holds a plurality of the power contacts 1102 (shown in FIG. 11) in a stacked configuration. The holder 1002 is of a two piece construction, having a base 1004 and a cover 1006. The power contacts 1102 are loaded onto the base 1004 and the cover 1006 is attached to the base 1004 to cover the power contact stack. The cover 1006 is attached to the base 1004 using latches 1008 and corresponding catches 1010.

The holder 1002 defines a cavity 1012 between the base 1004 and the cover 1006 extending from the first end 1022 to the second end 1024. When assembled, the holder 1002 includes a slot 1014 at the first end 1022 of the power connector 1000. When assembled, the holder 1002 also includes a slot 1016 at the second end 1024 of the power connector 1000. The slots 1014, 1016 on opposite ends of the power connector 1000 provide access to the cavity 1012. The slots 1014, 1016 provide access to the power contacts 1102. The power terminals 1018, 1020 are inserted into the slots 1014, 1016, respectively, for mating with the power contacts (not shown). Optionally, the slots 1014, 1016 may be oversized relative to the size of the power terminals 1018, 1020 to accommodate off-set of the power terminals 1018, 1020 with respect to the power connector 1000.

In an exemplary embodiment, the power connector 1000 slot 1014 has open sides 1026, 1028. The open sides 1026, 1028 permit the power connector 1000 to receive the power terminal 1018 from different angles or directions. For example, the power terminal 1018 may be inserted into the slot 1014 perpendicular to the longitudinal axis 1030. Alternatively, the power terminal 1018 may be inserted into the slot 1014 parallel to the longitudinal axis 1030. In an exemplary embodiment, the slot 1016 has open sides 1032, 1034. The open sides 1032, 1034 allows the power terminal 1020 to be received in the slot 1016 from different directions. For example, the power terminal 1020 may be inserted into the slot 1016 parallel to the longitudinal axis 1030. Alternatively, the power terminal 1020 may be inserted into the slot 1016 perpendicular to the longitudinal axis 1030.

FIG. 11 is an exploded perspective view of the power connector 1000. The power contacts 1102 are held within the power connector 1000. Each power contact 1102 has a unitary, one-piece construction and extends between a first end 1106 and a second end 1108 with an intermediate section 1104 therebetween. Optionally, the power contact 1102 may be symmetrical about a longitudinal axis 1110, defining an upper section and a lower section that are identical to one another.

The power contact 1102 includes a first receptacle section 1112 at the first end 1106. The first receptacle section 1112 extends between the first end 1106 and the intermediate section 1104. The first receptacle section 1112 is configured to receive a corresponding power terminal 1018 (shown in FIG. 10) therein. The first receptacle section 1112 is defined by an upper arm 1114 and a lower arm 1116, which have a gap 1118 therebetween. The power terminal 1018 is received in the gap 1118 between the upper and lower arms 1114, 1116. The mating interfaces 1120 are the portions of the upper and lower arms 1114, 1116 that engage the power terminal 1018. Distal ends of the upper and lower arms 1114, 1116 include protrusions that converge toward each other and define the mating interface 1120. The protrusions are curved to define a lead-in section that prevents stubbing when mating with the power terminal 1018.

In an exemplary embodiment, the upper and lower arms 1114, 1116 constitute spring beams that are configured to be deflected when mated with the power terminal 1018. The upper and lower arms 1114, 1116 may be spring biased against the sides 1036, 1038 (shown in FIG. 10) of the power terminal 1018 to ensure good electrical connection between the power contact 1102 and the power terminal 1018.

The power contact 1102 includes a second receptacle section 1122 at the second end 1108. The second receptacle section 1122 extends between the second end 1108 and the intermediate section 1104. The second receptacle section 1122 is configured to receive a corresponding power terminal 1020 (shown in FIG. 10) therein. The second receptacle section 1122 is defined by an upper arm 1124 and a lower arm 1126, which have a gap 1128 therebetween. The power terminal 1020 is received in the gap 1128 between the upper and lower arms 1124, 1126. The upper and lower arms 1124, 1126 extend outward from the intermediate section 1104. Optionally, the upper and lower arms 1124, 1126 may extend toward one another and converge at mating interfaces 1130. The mating interfaces 1130 are the portions of the upper and lower arms 1124, 1126 that engage the power terminal 1020. Distal ends of the upper and lower arms 1124, 1126 include protrusions that converge toward each other forming the mating interface 1130. The protrusions are curved to define a lead-in section that prevents stubbing when mating with the power terminal 1020.

In an exemplary embodiment, the upper and lower arms 1124, 1126 constitute spring beams that are configured to be deflected when mated with the power terminal 1020. The upper and lower arms 1124, 1126 may be spring biased against the sides of the power terminal 1020 to ensure good electrical connection between the power contact 1102 and the power terminal 1020.

In an exemplary embodiment, the intermediate section 1104 and the arms 1114, 1116, 1124, 1126 are an integral part of a unitary power contact 1102. High voltage electric power is efficiently transmitted through the power contact 1102 by having the power contact 1102 formed as a unitary structure.

The mating interfaces 1120, 1130 are curved to define a single point of contact between each arm 1114, 1116, 1124, 1126 and the corresponding power terminal 1018, 1020. The curved nature of the mating interfaces 1120, 1130 accommodate angular offset of the power terminal 1018, 1020 within the corresponding receptacle section 1112, 1122.

The power contact 1102 includes openings 1134 along the top and bottom edges of the intermediate section 1104. In an exemplary embodiment, the openings 1134 are offset from a centerline 1136 of the power contact 1102. When multiple power contacts 1102 are stacked together in a stacked configuration, adjacent power contacts 1102 may be inverted with respect to one another. The offset of the opening 1134 creates a staggered arrangement of the power contacts 1102 within the stacked configuration by placing the opening 1134 on alternating sides of the centerline 1136.

In an exemplary embodiment, the holder 1002 includes tabs 1140 extending into the cavity 1012 from the base 1004 and the cover 1006. The power contacts 1102 are loaded into the cavity 1012 such that the tabs 1140 are received in the openings 1134. In an exemplary embodiment, adjacent power contacts 1102 within the stack 1138 are inverted (rotated 180°) with respect to one another and loaded onto the tab 1140. Because the openings 1134 are off-set, the power contacts 1102 are staggered within the stack. The number of power contacts 1102 in the stack 1138 is scalable to allow increase or decrease in current carrying capability of the power connector.

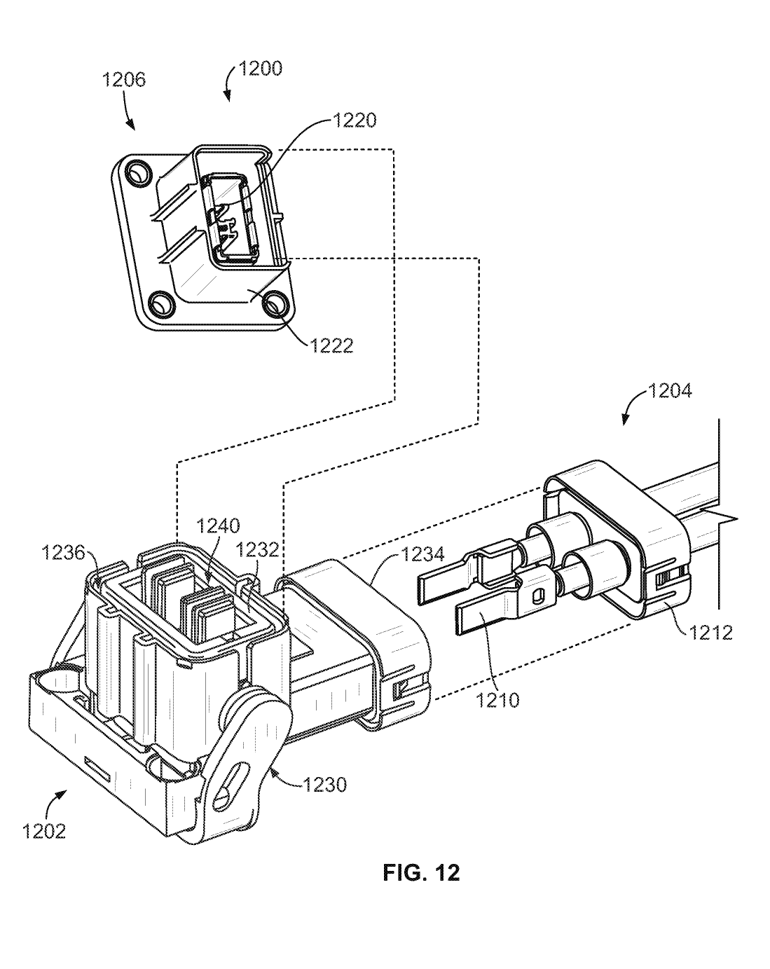

FIG. 12 illustrates an alternate power connector system 1200 in accordance with an embodiment. The power connector system 1200 includes a power connector assembly 1202, a first power device in the form of a cable assembly 1204 and a second power device in the form of a header assembly 1206. The cable assembly 1204 includes power terminals 1210 terminated to ends of cables 1212. The power terminals 1210 may be bussed together as part of a power bus bar in some embodiments. A cable block 1214 holds the cables 1212. The header assembly 1206 includes power terminals 1220 hold by a header housing 1222. The power terminals 1210 may be bussed together as part of a power bus bar in some embodiments. The header assembly 1206 may be mounted on a power distribution module of a vehicle.

The power connector assembly 1202 interconnects the cable assembly 1204 and the header assembly 1206. In the illustrated embodiment, the power connector assembly 1202 constitutes a right angled plug. The power connector assembly 1202 may have other configurations in alternative embodiments. In an exemplary embodiment, the power connector assembly 1202 constitutes a double-ended, high current connector assembly, which serves to conduct high voltage and high current between the cable assembly 1204 and the header assembly 1206. The power connector assembly 1202 accommodates angular and/or positional misalignment of the power terminals 1210 and/or the power terminals 1220. The power connector assembly 1202 allows for right angle redirection within the connector. The second power device may be a header connector mounted on a power distribution module. The header comprises one or more power terminals . . . .

The power connector assembly 1202 includes a housing 1230 holding a power connector 1240. The housing 1230 extends between a first side 1232 and a second side 1234. The first and second sides 1232, 1234 are oriented at right angles with respect to one another. The housing 1230 includes a chamber 1236 that receives the power connector 1240. In an alternative embodiment, the housing 1230 may include a plurality of chambers 1236 therein that receive corresponding power connectors 1240.

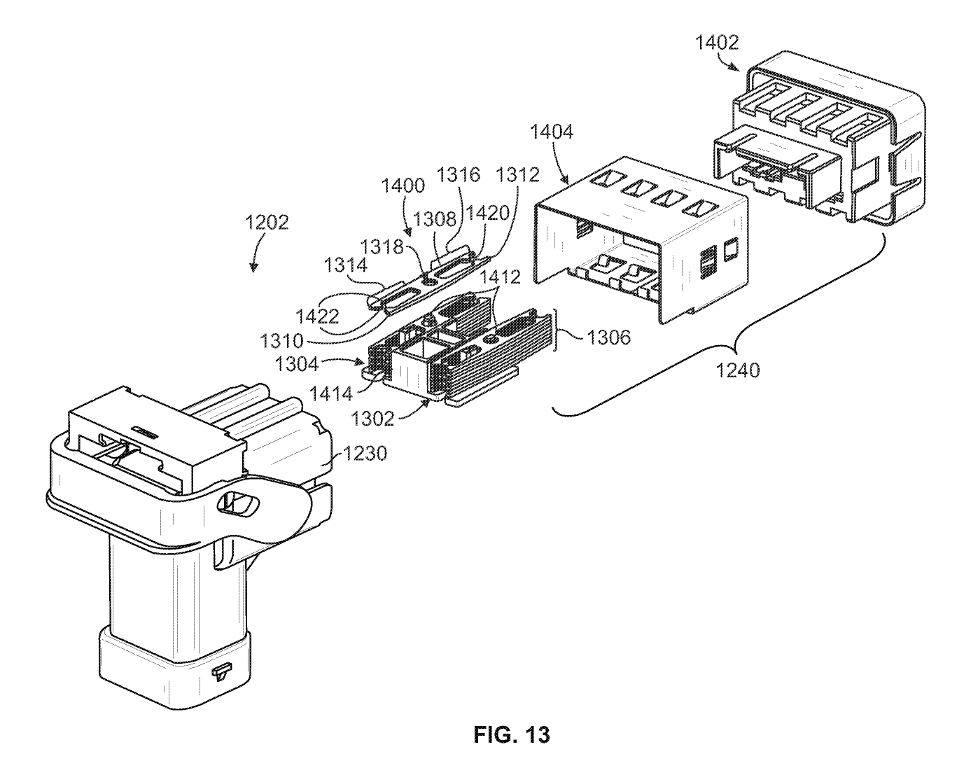

FIG. 13 is an exploded view of the power connector assembly 1202. The power connector assembly 1202 includes the power connector 1240 held within the housing 1230.

The power connector 1240 includes a plurality of sub-connectors 1302, 1304. Each sub-connector 1302, 1304 holds a power contact stack 1306. The power contact stack 1306 comprises multiple power contacts 1308. Each sub-connector 1302, 1304 is capable of receiving one power terminal 1210 (shown in FIG. 12) and one power connector 1220 (shown in FIG. 12) therein that mates with the power contacts 1308.

The power contacts 1308 are similar to the power contacts described above. The power contacts 1308 extend between first and second ends 1310, 1312 and have first and second receptacle sections 1314, 1316. The power contacts 1308 include openings 1318.

The power connector 1240 includes a holder 1400 that holds groups of the power contacts 1308 in different power contact stacks 1306. The power connector 1240 also includes a housing 1402 that holds the holder 1400 and a shield 1404 that surrounds portions of the housing 1402 and/or the holder 1400. The shield 1404 provides electrical shielding around the power contacts 1308. The shield 1404 is electrically isolated from the power contacts 1308.

The power contact stacks 1306 are assembled in a similar manner as described above. The power contacts 1308 are loaded onto corresponding tabs 1412 within a cavity 1414 of the holder 1400. The openings 1318 are loaded onto the tabs 1412. The openings 1318 are elongated to allow the power contacts 1308 to float within the cavity 1414. In the illustrated embodiment, the holder 1400 includes two cavities 1414, each having a tab 1412 that receives a different stack 1306 of power contacts 1308. Any number of cavities 1414 may be provided. The power contacts 1308 may be rotatably held by the holder 1400 such that the power contacts 1308 can accommodate offset of the terminals 1210, 1220 (e.g. vertical offset, angular offset, blade twist, and the like). The power contacts 1308 may be rotated, twisted or tilted to accommodate angular or positional offset of the power terminals 1210, 1220.

The power contacts 1308 have protrusions 1420 that extend from arms 1422 thereof into gaps or receptacles 1424 defined between the arms 1422. The protrusions 1420 define mating interfaces 1426 for mating with the power terminals 1210, 1220. In the illustrated embodiment, the protrusions 1420 on one end of the power contacts 1308 are stepped inward from the distal ends thereof, while the protrusions 1420 on the opposite end of the power contacts 1308 are provided generally at the distal ends, and not stepped inward. In an exemplary embodiment, the power contacts 1308 are loaded into the holder 1400 in inverted positions (e.g. rotated 180°, such that some power contacts 1308, for example adjacent power contacts 1308, have mating interfaces 1426 that are staggered and define a sequenced mating with the power terminals 1210 and/or 1220.

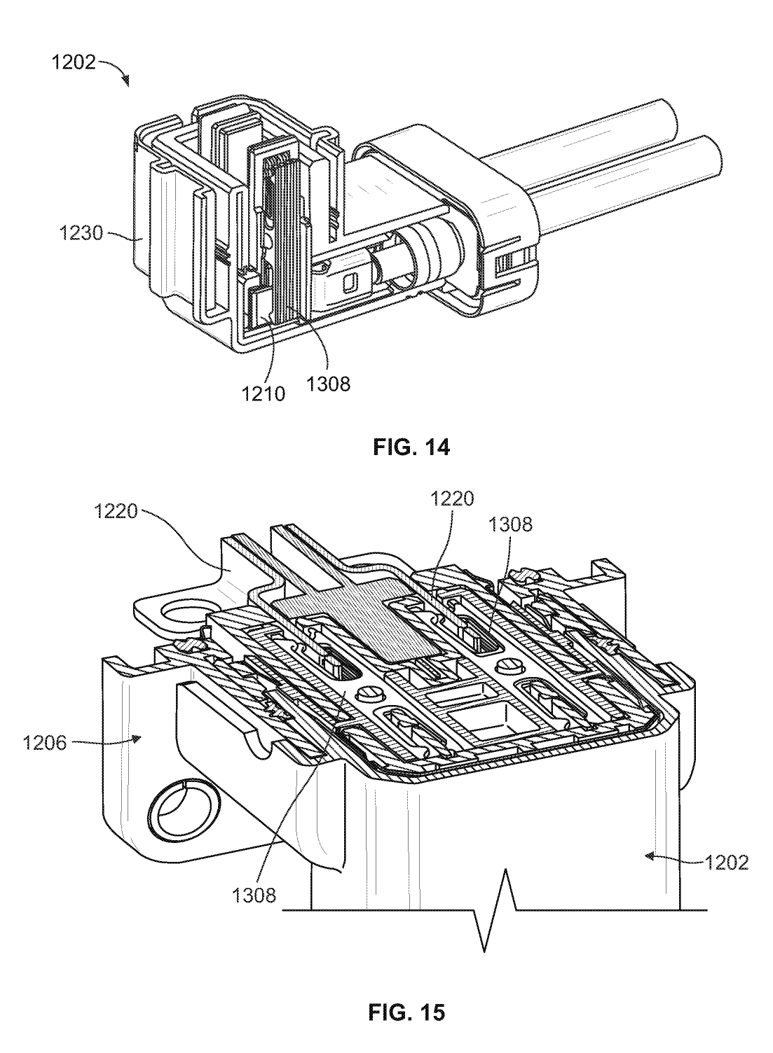

FIG. 14 is a sectional view of the power connector assembly 1202 with a portion of the housing 1230 removed to show the power terminals 1210 mated with the power contacts 1308. FIG. 15 is a cross-sectional view of the power connector assembly 1202 mated with the header assembly 1206. FIG. 15 illustrates the power terminals 1220 mated with the power contacts 1308.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A power connector comprising:
a holder having a cavity and a tab extending into the cavity;
power contacts received within the cavity in a stacked configuration, the power contacts having a first end and a second end, the power contacts having a first receptacle section at the first end configured to receive a power terminal therein, the power contacts having a second receptacle section at the second end configured to receive a power terminal therein, each power contact having an opening, wherein the tab is received in the opening to position the contact within the cavity.

2. The power connector of claim 1, wherein the power contacts are movable within the cavity, the power contacts pivoting about the tab.

3. The power connector of claim 1, wherein the first receptacle section includes a forked contact portion configured to receive the power terminal therein, the second receptacle section including a forked contact portion configured to receive the power terminal therein.

4. The power connector of claim 1, wherein the power contact includes an intermediate section between the first end and the second end of the power contact, the first receptacle section including an upper arm extending from the intermediate section and a lower arm extending from the intermediate section, a gap being formed between the upper and lower arms of the first receptacle section that receives the power terminal therein, the second receptacle section includes an upper arm extending from the intermediate section and a lower arm extending from the intermediate section, a gap being formed between the upper and lower arms of the second receptacle section that receives the power terminal therein.

5. The power connector of claim 1, wherein the power contact includes upper arms, lower arms, and an intermediate section between the first end and the second end, wherein the upper arms, the lower arms, the first receptacle section, the second receptacle section and the intermediate section are of a unitary, one-piece construction.

6. The power connector of claim 1, wherein the first receptacle section includes opposed arms configured to be biased against opposite sides of the power terminal, the second receptacle section including opposed arms configured to be biased against the opposite sides of the power terminal.

7. The power connector of claim 1, wherein the power contacts are stacked such that the first receptacle sections are aligned with one another to receive the same power terminal and the second receptacle sections are aligned with one another to receive the same power terminal.

8. The power connector of claim 1, wherein the power contacts are staggered such that at least some of the first ends are offset from other first ends and such that at least some of the second ends are offset from other second ends.

9. The power connector of claim 1, wherein the opening is offset from a center line of the corresponding power contacts, adjacent power contacts being received in the cavity in inverted orientations such that the first ends of adjacent power contacts are staggered with respect to each other and such that the second ends of adjacent power contacts are staggered with respect to each other.

10. The power connector of claim 1, wherein the tab is cylindrical, the power contacts extending along longitudinal axes between the first and second ends, the openings being elongated in a direction transverse to the contact axes, the power contacts being loaded onto the tab and being allowed to float on the tab in directions transverse to the contact axes.

11. A power contact comprising:
a contact body having a first end and a second end with an intermediate section therebetween, the contact body having a first receptacle section between the intermediate section and the first end, the first receptacle section having upper and lower arms, the first receptacle section being configured to receive a power terminal therein, the contact body having a second receptacle section between the intermediate section and the second end, the second receptacle section having upper and lower arms, the second receptacle section being configured to receive a power terminal therein, the contact body having an opening in the intermediate section offset from a centerline of the contact body.

12. The power contact of claim 12, wherein the first receptacle section includes a forked contact portion configured to receive the power terminal therein, the second receptacle section including a forked contact portion configured to receive the power terminal therein.

13. The power contact of claim 12, wherein the first receptacle section includes an upper arm extending from the intermediate section and a lower arm extending the intermediate section, a gap being formed between the upper and lower arms of the first receptacle section that receives the power terminal therein, the second receptacle section includes an upper arm extending from the intermediate section and a lower arm extending from the intermediate section, a gap being formed between the upper and lower arms of the second receptacle section that receives the power terminal therein.

14. The power contact of claim 12, wherein the first receptacle section, the second receptacle section and the intermediate section are of a unitary, one-piece construction.

15. The power contact of claim 12, wherein the first receptacle section includes opposed arms configured to be biased against opposite sides of the corresponding power terminal, the second receptacle section including opposed arms configured to be biased against the opposite sides of the corresponding power terminal.

16. The power contact of claim 12, wherein the contact body extends along a contact axis between the first and second ends, an opening being elongated in a direction transverse to the contact axis to allow floating of the contact body in a direction transverse to the contact axis.

17. A power connector assembly comprising:
a housing having chambers; and
power connectors received in the chambers, the power connectors comprising:
a holder having a cavity and a tab extending into the cavity; and
power contacts received within the cavity in a stacked configuration, the power contacts having a first end and a second end, the power contacts having a first receptacle section at the first end configured to receive a power terminal therein, the power contacts having a second receptacle section at the second end configured to receive a power terminal therein, the power contacts having an opening, wherein the tab is received in the openings to position the power contacts within the cavity.

18. The power connector assembly of claim 17, wherein the power contacts are movable within the cavity, the power contacts pivoting about the tab.

19. The power connector assembly of claim 17, wherein the power contact includes an intermediate section between the first end and the second end of the power contact, the first receptacle section including an upper arm extending from the intermediate section and a lower arm extending the intermediate section, a gap being formed between the upper and lower arms of the first receptacle section that receives the power terminal therein, the second receptacle section includes an upper arm extending from the intermediate section and a lower arm extending from the intermediate section, a gap being formed between the upper and lower arms of the second receptacle section that receives the power terminal therein.

20. The power connector assembly of claim 17, wherein the power contact includes an intermediate section between the first end and the second end, the first receptacle section, the second receptacle section and the intermediate section being of a unitary, one-piece construction.
